(19) United States
(12) Patent Application Publication
(10) Pub. No.: US 2023/0350980 A1
(43) Pub. Date: Nov. 2, 2023

(54) Management of Storage Devices Utilizing Non-Fungible Tokens

(71) Applicant: Western Digital Technologies, Inc., San Jose, CA (US)

(72) Inventors: Shashank AGRAWAL, San Jose, CA (US); Cyril GUYOT, San Jose, CA (US)

(21) Appl. No.: 18/161,209

(22) Filed: Jan. 30, 2023

Related U.S. Application Data
(60) Provisional application No. 63/326,185, filed on Mar. 31, 2022.

(51) Int. Cl. G06F 21/10

(52) U.S. Cl. CPC G06F 21/10; G06F 2221/0711; G06F 2221/0755

(57) ABSTRACT

System, methods, and devices described herein utilize blockchain systems to tie physical storage devices to a digital non-fungible token (NFT). By utilizing this association, the manufacturer can provide software to assure purchasers that their devices are genuine. Furthermore, ownership transfers can be verified and utilized as a means to provide accurate provenance of a storage device, which can increase the value of the device in certain collectible situations. Associating a storage device to an NFT can include pair the drive with a unique identifier provided by the manufacturer, and an address that consists of an encryption key and a secret key that only the owner will know. A user can then encrypt their data and transfer ownership of the storage device to a new owner who will generate a new encryption key. The new owner cannot access data stored on the device, preventing the original owner’s data from being compromised.

### PRIORITY

This application claims the benefit of and priority to U.S. Provisional Application No. 63/326,185, entitled “Management of Storage Devices Utilizing Non-Fungible Tokens,” filed on Mar. 31, 2022, the entirety of which is being incorporated herein by reference.

### FIELD

The present disclosure relates to managing storage devices. More particularly, the present disclosure relates to utilizing non-fungible tokens to manage ownership of a plurality of storage devices and/or devices with storage devices.

### BACKGROUND

Storage devices are designed to be durable and long-lasting. Many storage devices have a typical warranty period of 5 years but could last much longer in practice. As a result, there is a huge market for buying and selling used drives. As with any other used item, the history of a device plays a very important role in determining its price (apart from the device specification itself). A reliable and accurate source of historical data is quite valuable from a buyer’s perspective. The value of such data is even higher if the device up for sale is considered a collectible item. Many different things could make a storage device collectible: the current owner or one of the previous owners may be a well-known person, the device itself may be unique in some way (comes in a special encasing, signed by a celebrity, part of a limited series, designed for an extreme setting, etc.), short history of ownership, etc.

Sellers in a used drive market also have some concerns. The most important of them all is access to their private data after a device has been sold. Sellers could try to erase data manually with the help of some software that typically attempts to overwrite file system data blocks, or to use the storage device’s own erasure routines. Unfortunately, such software is often practically limited in its ability to truly erase all relevant blocks through the storage device interface: wear-leveling in SSDs essentially preclude the file system data block overwrite approach. But even if the drive’s own erasure routine is used, some failed data blocks may be un-erasable, while still remaining readable. Faced with this problem, a more effective approach would be to keep the data on a drive encrypted at all times and to just erase the encryption key before making a sale. Encrypted data without the ability to decrypt is no better than random junk data.

Additionally, buyers of storage devices may encounter problems purchasing genuine storage devices from online sellers and resellers. Bad actors may attempt to utilize online retail markets to sell counterfeit storage devices that are indistinguishable from genuine storage devices when viewing online. The counterfeit storage devices can also be configured to present as authentic to a user, even when plugged in and examined for storage size by various operating systems. A user may not be aware the storage device is counterfeit until it is used or fills up the memory array that is much smaller than advertised. This has led to many buyers avoiding purchasing storage devices online and creates distrust in the marketplace as there is no easy way for a layperson to determine if a storage device is authentic and was manufactured by a reputable storage device maker.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 is a conceptual diagram of a non-fungible token storage device system in accordance with various embodiments of the disclosure;

FIG. 2 is a conceptual diagram of a host-computing device with a storage system associated with a non-fungible token in accordance with various embodiments of the disclosure;

FIG. 3 is a schematic block diagram of an example storage device suitable for being associated with a non-fungible token in accordance with various embodiments of the disclosure;

FIG. 4 is an example process of transferring ownership of a device associated with a non-fungible token in accordance with various embodiments of the disclosure;

FIG. 5 is a flowchart depicting a process for determining the provenance of a storage device associated with a non-fungible token in accordance with various embodiments of the disclosure;

FIG. 6 is a flowchart depicting a process for operating a storage device associated with a non-fungible token in accordance with various embodiments of the disclosure;

FIG. 7 is a flowchart depicting a process for securing a storage device associated with a non-fungible token in accordance with various embodiments of the disclosure; and

FIG. 8 is a flowchart depicting a process for transferring ownership of a storage device associated with a non-fungible token in accordance with various embodiments of the disclosure.

### DETAILED DESCRIPTION

In response to various problems known in the field, devices and methods are discussed herein that associate storage devices and/or storage systems to unique non-fungible tokens stored and accessible in a blockchain. By utilizing these methods and practices, ownership, and authenticity can be verified for each storage device. This can allow restrictions to access only by authorized users or can help to avoid purchase of counterfeit products. In some embodiments, the ownership verification is accomplished upon first sale of the device only. However, in further embodiments, a light blockchain client can be installed on the storage device/system to verify current ownership and change access restrictions based on new ownership transfers. In still other embodiments, the storage device/system itself can be utilized to store metadata and/or other NFT-related data within the memory array of a storage device to be utilized as a primary means of accessing the data or as a backup for other cloud-based services.

Blockchain technology is a good starting point to build a general framework to address the concerns of buyers and sellers discussed above. Many popular blockchain-based systems allow open participation: anyone can join the network, monitor the network’s activity, verify records added to the chain, etc. While some blockchains suffer from privacy, scalability, or volatility issues, they may not be relevant in every setting.

Non-fungible tokens, or “NFTs”, are increasingly popular. Often, they can be used to represent unique digital items on a blockchain (hence why it isn’t fungible with other digital items on the same blockchain). Many different items are currently being traded as NFTs such as digital art, games, music, sports, etc. Currently, a large number of NFTs are being built on the ERC-721 standard and are traded on and/or associated with the Ethereum blockchain. The ERC-721 interface can provide various operational methods to perform various functions, such as, but not limited to, finding the owner of an NFT, and transferring ownership of an NFT, etc. A contract that implements the ERC-721 interface will keep an internal mapping of unique identifiers, which represent the NFTs, to addresses, which represent the owners.

Unique identifiers alone don’t often say much about an NFT. In fact, they may not say anything at all as they are only supposed to be unique. However, in various embodiments, each identifier can be associated with some metadata (optional in the standard though) that can provide useful and often crucial information about the NFT. One could even say that this metadata is what properly defines an NFT. For a digital cat (e.g., in the blockchain-based CryptoKitties game that produces cat NFT items), the metadata may have the name, link to an image, description, etc. for each cat associated with an NFT.

The metadata of an NFT could be stored on-chain or off-chain. In many embodiments, it would be preferred to store all the metadata (such as the NFT ownership and transaction history) on the chain itself so that the risk of losing the data is minimized. In the case of digital art, for example, this would mean storing the art file (jpg, .png, etc.) itself on the chain.

Unfortunately, on-chain storage is currently quite expensive. As a result, in a number of embodiments, NFT metadata is not stored on the chain. Methods within the ERC-721 standard can provide a way to obtain a public URL where metadata in the form of a JSON dictionary could be stored. The main NFT or other storage device data can be configured to be stored elsewhere (e.g., AWS, Google Cloud, etc.) and the dictionary would have a pointer to it.

Various embodiments described herein can introduce an element of centrality in the NFT scheme of things. While an NFT’s ownership history may persist over time due to the use of blockchain to record transactions, the actual collectible item that the NFT represents may become inaccessible if the service hosting it goes down. To deal with this, people have been looking at storing the NFT metadata on decentralized networks that are specifically designed for storing large amounts of data (e.g., Filecoin, etc.).

Contracts on blockchain-based platforms like Ethereum can be executed in a decentralized manner. Anyone in the network could invoke any method on a contract by paying some fee and all the invocations are recorded on the blockchain. Given the contract and the history of all invocations, which is public, anyone could determine the current state of the contract. In particular, in the context of NFTs, anyone would be able to determine the current owner as well as all the past owners. In fact, all ownership transfers of an NFT along with any other actions are publicly visible. One could also go through the contract code to verify that the NFT and all the associated operations are defined and implemented properly and that there are no serious bugs or backdoors. As a result, a public blockchain that supports smart contracts is a suitable medium to keep track of a (digital) collectible item.

Representing storage devices as NFTs on a blockchain could provide many benefits, especially if there is demand for them in resale markets. In a number of embodiments, a smart contract, such as one conforming to the ERC-721 standard for storage devices where each device is represented with a unique identifier may be utilized. Not all devices need to be on the same smart contract or blockchain though. We could group similar devices together, where similarity depends on the context, and have a contract each for every group. Let us denote a contract of this type by SC.

There are several attributes associated with a storage device like brand, type (HDD, SSD, etc.), capacity, interface, compatibility, dimensions, etc. In many embodiments, this information could all be stored very cheaply on the chain itself in the form of metadata. Metadata could be stored in the internal state of smart contract itself or within a separate contract. In further embodiments, this could be created and deployed by a device manufacturer. Manufacturers could reserve the right to add new identifiers to the contract (this could be enforced by exposing a method that requires a digital signature from the manufacturer). A new identifier for a device can also be added to the contract when the device is sold by the manufacturer (i.e., upon the first sale). The contract will expose a method to fetch the attributes associated with the identifier (i.e., the device).

In various embodiments, device manufacturers could deploy their own contract (or a group of contracts) on a blockchain. A link to the contract on their website may also be provided so that users can distinguish the official contracts from any scams. Likewise, a validation tool and/or software may be issued by the manufacturer which can receive data associated with the storage device and help determine if a device came from the manufacturer or was crafted elsewhere by bad actors attempting to sell counterfeit hard drives.

So far, nothing links the type of NFTs being created with an actual physical storage device. In fact, NFTs usually have no direct connection with physical objects at all; they primarily represent digital items. How can we connect a unique identifier stored on a blockchain (with certain attributes) to an actual device? At a high level, various embodiments can connect the ownership information of an identifier to the ability to access data on the associated device.

Most storage devices are configured to support encryption. If encryption is enabled, then all the data written to the device is encrypted. Similarly, any data read from the device needs to be decrypted first. Encryption and decryption involve a secret key that is usually generated on the device itself. The secret key is itself encrypted under a user chosen secret (e.g., password). If a user can provide the right secret, then the key can be recovered, and data could be encrypted/decrypted.

On the other hand, if the user chosen secret is not known, then the device is effectively locked for all practical purposes. Even if someone can open up the device and get their hands on the raw data stored in it, they would just have a bunch of encrypted data and an encrypted key, which would not be of any use. Thus, if a user is not careful in choosing secrets (e.g., chooses a bad password), then an attacker may be able to guess it in a small number of attempts and gain access to the device. On the other hand, if user picks a cryptographically strong random number as the secret (e.g., a 128-bit random binary value), then it would be infeasible for any attacker to guess the secret in any reasonable amount of time.

Smart contracts can store a mapping from unique identifiers to addresses. These addresses can be hashes of public keys of a signature scheme like ECDSA. (Public keys of a signature scheme are also sometimes called verification keys because they help to verify signatures.) Only the person who knows the private key corresponding to an address would be able to produce valid signatures under it. So, if a unique identifier is attached to an address A, a signature under A can “prove” ownership of the unique identifier and can be used, for instance, to transfer ownership (i.e., sell the NFT).

In many embodiments, the address A can be used to protect the secret encryption key, say k, on the device associated with the unique identifier. We could not use a symmetric encryption scheme for k’s protection though because A is not a secret. However, A can be used as an encryption key within an asymmetric encryption scheme in a number of embodiments. Unfortunately, A is often the hash of some public key of a signature scheme, so one doesn’t know what the corresponding decryption key would be. Even if A were not a hash, those skilled in the art will recognize that it is not recommended to use the same public key for both signing and encryption.

Therefore, in some embodiments we can expand an address to include not just the hash of a public key for a signature scheme but also the public key for an encryption scheme like RSA, ElGamal, Paillier, etc. So, an address A can be defined as A = (pk_{sig}, pk_{enc}), where pk_{sig} is the public key of a signature scheme and pk_{enc} is the public key of an asymmetric encryption scheme. In these embodiments, we can use pk_{enc} to protect the device encryption key k.

For example, suppose it is desired to associate a device with its NFT on the blockchain. The NFT is represented by a unique identifier. Suppose an address A = (pk_{sig}, pk_{enc}) is associated with that unique identifier. The device can generate an encryption key k for encrypting/decrypting all data and will encrypt k itself under pk_{enc}. Now D’s access will only be available to the person who knows the secret key corresponding to pk_{enc}, the key that can be used to decrypt k.

The above examples highlight an issue of who or what will provide pk_{enc} to the device and what will happen when it needs to be changed at a later date, such as when the device and associated NFT are sold to a new owner? When a device is sold for the first time if can be configured with a first address A = (pk_{sig},pk_{enc}). In various embodiments, for example, the manufacturer could “initialize” or otherwise assign the device with pk_{enc} along with creating an NFT associated with the device on the blockchain. However, the device may be subsequently sold, and that second owner could sell it again, and so on. Therefore, there should be a way to update pk_{enc}.

In a number of embodiments, the device may be initialized with both pk_{enc} and pk_{sig}, so that if it is sold with address A = (pk_{sig}, pk_{enc}), the original owner could provide a signature on A under pk_{sig} to indicate a change of ownership by initiating a request. In these embodiments, the device can generate a second encryption key k^{′} and store it encrypted under pk^{′}_{enc}. In this way, the original owner’s data may still be on the device (in an encrypted form) but without the previous key k, the stored data is inaccessible and indistinguishable from junk data.

However, without more, the above embodiments require the first owner to do the right thing. The first owner may update the device with an incorrect address (maliciously or accidently) before handing over the physical device to the new owner. One solution to this would be to build a dispute/refund mechanism into the smart contract associated with the NFT but administering such a mechanism would be burdensome.

The embodiments described above involve a disconnect between the transfer of ownership on the blockchain and the same transfer on the device side. In many embodiments, this can be resolved by not depending on the seller doing the right thing—or even being involved. Given the device and given the record of the corresponding NFT sale, anyone should be able to transfer device ownership. Moreover, in the absence of such a sale, device ownership transfer should not be possible.

Currently, when utilizing Ethereum, every account is associated with four attributes: nonce, balance, storage root, and code hash. The storage root is a 256-bit hash of the root node of a Merkle Patricia tree that encodes the storage contents of the account, also called the account state. The smart contract can also be represented as an account. This account will internally store a mapping from identifiers to addresses (as discussed above).

When an NFT sale is made, the corresponding identifier will be mapped to a new address. If the storage root of the smart contract’s internal state is available, one could provide the (identity, address) pair and a path in the Merkle Patricia tree to “prove” that such a pair is now indeed a part of contract’s state. The size of the path is only logarithmic in the size of the state. Moreover, one cannot provide a valid proof for an (identity, address) pair that does not exist in the contract’s state.

Another important point to note about Ethereum is that every block contains a 256-bit hash of the latest state of all accounts, after all transactions are executed and finalizations applied. This hash is called the state root and is included in the block header. Given a state root, one can prove that a certain (identity, address) pair is stored in the smart contract in two steps: (1) reveal the storage root of the smart contract and show a path in the corresponding tree for the (identity, address) pair, and (2) then show another path in the state root tree for the inclusion of storage root in it. Observe that only the block header information and the two short proofs (in the form of paths in a tree) are needed to verify that a certain (identity, address) pair is included in the current smart contract. Importantly, the whole block, which is much bigger, is not needed.

Now, many embodiments can bridge the disconnect between ownership transfer on blockchain and on the device, by configuring the device to have lightweight blockchain client installed. When a manufacturer sells a device (first sale), it can add or install a new (identity, address) pair for the sale on SC. Suppose the add transaction is added to the blockchain at height h and some small number 1 of confirmations are needed to ensure that the transaction will not be reverted. The manufacturer can provide all the block headers up to height h + 1 to the device along with a proof that (identity, address) pair is included at height h. Indeed, not just the manufacturer but anyone can provide this information to the device since it’s all public. The blockchain client on the device will verify this information. If it checks out, the device will generate a fresh encryption key, encrypt it under pk_{enc} included in the address (as discussed before), and store the encrypted value. In certain embodiments, the device can also store the height value h to prevent any rollback attacks.

For any subsequent sale, when the (identity, address) pair is updated with a new address at height h^{′}, the seller, buyer, or anyone else can provide all the block headers from h to h^{′}+1 along with an inclusion proof of the new pair to the device for it to generate a fresh encryption key tied to the new owner, effectively transferring the ownership to him/her. The device will also check that h^{′} > h. In some embodiments, this can be accomplished through software provided by the manufacturer for use in the field. However, direct messaging between the host-computing device and the storage device is also contemplated.

In further embodiments, once the NFT is attached to the physical storage device, it can be configured to store the entirety of the NFT’s metadata. In still more embodiments, the storage device could be configured with at least one portion of or entire memory array that can disallow any write permission after data has been entered in order to restrict modification of NFT data stored on the device. This may be beneficial as third-party storage services may go offline (temporarily or permanently) or may face a data breach. A physical device in the possession of the owner and locked can provide a much higher level of availability, security, and control. The cost of such embodiments may be negligible when compared to the cost of the NFT itself and can provide extra peace of mind for the owners of the NFT. In additional embodiments, the metadata may still be stored with a third-party cloud service, but the owner could always back it up on their own personal storage device as described herein. When a specific device is linked to an NFT right at conception, transferring ownership of the metadata can occur in a convenient, decentralized, and secure manner.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “logic,” “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations, which, when joined logically together, comprise the function and achieve the stated purpose for the function.

Indeed, a function of executable code may include a single instruction or many instructions and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but is not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user’s computers and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages) or other discrete electrical devices in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive and/or mutually inclusive unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/ or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

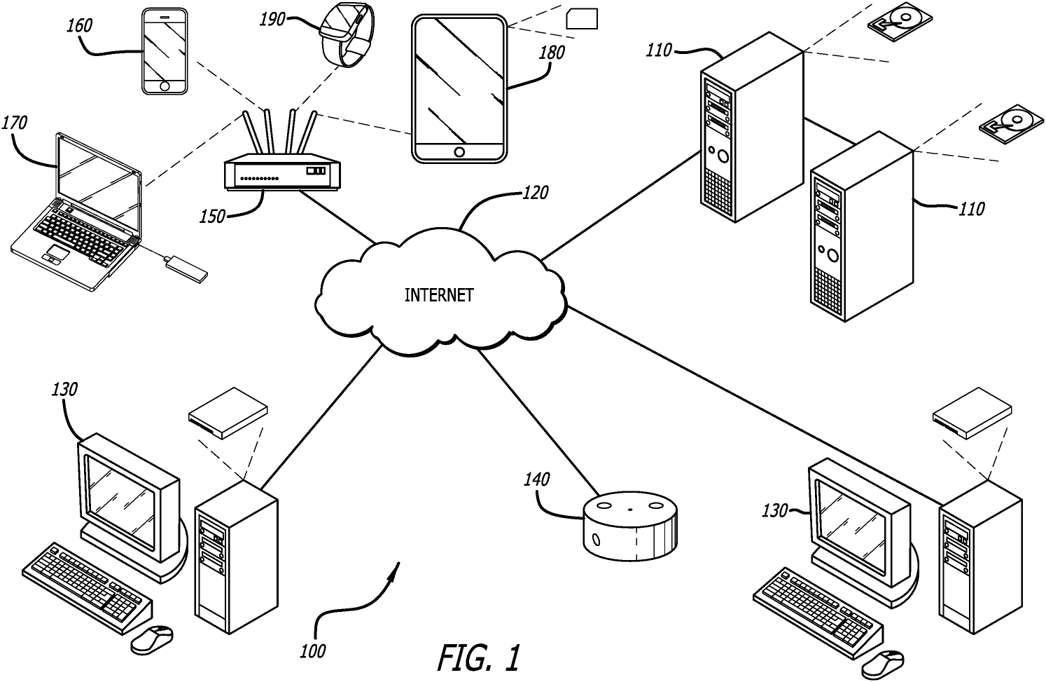

Referring to FIG. 1, a conceptual diagram of a non-fungible token (NFT) storage device system 100 in accordance with various embodiments of the disclosure is shown. The NFT storage device system 100 may comprise a plurality of devices that comprise various storage devices associated with a unique NFT. In many embodiments, servers 110 can be connected to a network 120 such as, for example, the Internet. Servers 110 can be configured to include storage devices such as, but not limited to, hard disk drives (HDDs) that can transmit a variety of data across the network 120 to any number of computing devices such as, but not limited to, voice-assisted computing devices 140, personal computers 130, and mobile computing devices including laptop computers 170, cellular phones 160, portable tablet computers 180 and wearable computing devices 190. In additional embodiments, NFT data may be mirrored in additional cloud-based service provider servers, blockchain nodes, or edge network systems. In still additional embodiments, the servers 110 can be hosted as virtual servers within a cloud-based service that utilize one or more storage devices as NFTs.

As seen in the example embodiment of FIG. 1, various devices may include an NFT-associated storage device. Servers 110 may be equipped with one or more HDDs associated with unique NFT identifications. Personal computers 130 may be configured with one or more solid-state storage devices (SSDs) with unique NFT identifications. Additionally, other portable computing devices, such as the tablet 180, may include a removeable storage device such as a secure digital card (SD Card) that can be manufactured such that it is associated with a unique identification number stored on a particular blockchain.

In further embodiments, the sending and receiving of NFT related data can occur over the network 120 through wired and/or wireless connections. In the embodiment depicted in FIG. 1, the mobile computing devices 160, 170, 180, 190 are connected wirelessly to the network 120 via a wireless network access point 150. It should be understood by those skilled in the art that the types of wired and/or wireless connections between devices on the NFT storage device system 100 can be comprised of any combination of devices and connections as needed.

In various embodiments, the NFT storage device system 100 may broadly accept and/or process new NFT data from additional storage devices via any number of devices. This NFT data may, in some embodiments, generate a plurality of data related to the NFT or one or more ownership and/or metadata transactions. This data related to the NFTs, or transactions can be generated from and/or stored within the storage devices within devices such as the personal computers 130, servers 110, and/or mobile computing devices such as the tablet 180.

In still further embodiments, the NFT data may be stripped of personal identifying data (i.e., anonymized) and transmitted to the servers 110 and/or other cloud-based services for processing. The processed data may then be returned to an NFT-associated storage device, for output or further processing by a host computing device or to the user. Based on the transaction type occurring, the user of the NFT-associated storage device may subsequently generate digital signature data that can be verified or otherwise transmitted back to the servers 110 or other blockchain nodes to complete one or more transactions.

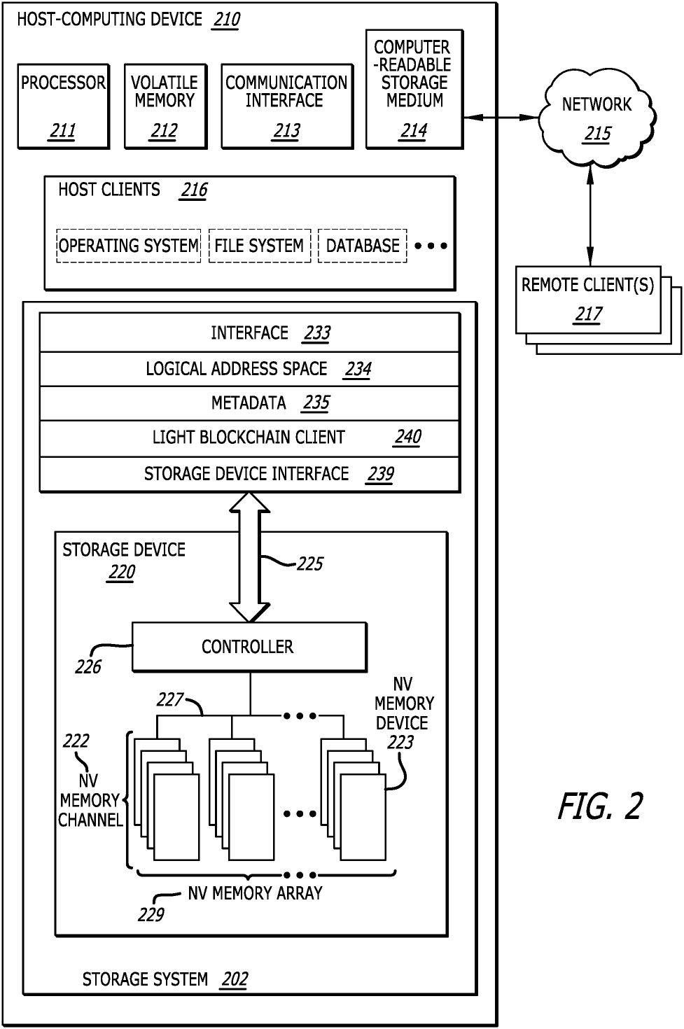

Referring to FIG. 2, a conceptual diagram of a host-computing device with a storage system as a non-fungible token in accordance with various embodiments of the disclosure is shown. In various embodiments, a host computing device 210 comprises a storage device that is associated with a unique identification number on a blockchain, such as those discussed in FIG. 1. However, additional embodiments may comprise a storage system 202 that is associated with and communicates with the blockchain via a blockchain client 240. In further embodiments, the blockchain client 240 may be installed as a light blockchain client within the storage device 220 itself, such as those devices depicted in FIG. 1.

The processor 211 of the host computing device 210 may include one or more central processing units, one or more general-purpose processors, one or more application-specific processors, one or more virtual processors (e.g., the host computing device 210 may be a virtual machine operating within a host), one or more processor cores, or the like. The communication interface 213 may include one or more network interfaces configured to communicatively couple the host computing device 210 and/or controller 226 of the storage device 220 to a communication network such as an Internet Protocol (IP) network, a Storage Area Network (SAN), wireless network, wired network, or the like.

The storage device 220, in various embodiments, may be disposed in one or more different locations relative to the host computing device 210. In one embodiment, the storage device 220 comprises one or more non-volatile memory devices 223, such as semiconductor chips or packages or other integrated circuit devices disposed on one or more printed circuit boards, storage housings, and/or other mechanical and/or electrical support structures. For example, the storage device 220 may comprise one or more direct inline memory module (DIMM) cards, one or more expansion cards and/or daughter cards, a solid-state-drive (SSD) or other hard drive device, and/or may have another memory and/or storage form factor. The storage device 220 may be integrated with and/or mounted on a motherboard of the host computing device 210, installed in a port and/or slot of the host computing device 210, installed on a different host computing device 210 and/or a dedicated storage appliance on the network 215, in communication with the host computing device 210 over an external bus (e.g., an external hard drive), or the like.

The storage device 220, in one embodiment, may be disposed on a memory bus of a processor 211 (e.g., on the same memory bus as the volatile memory 212, on a different memory bus from the volatile memory 212, in place of the volatile memory 212, or the like). In a further embodiment, the storage device 220 may be disposed on a peripheral bus of the host computing device 210, such as a peripheral component interconnect express (PCI Express or PCIe) bus such, as but not limited to a NVM Express (NVMe) interface, a serial Advanced Technology Attachment (SATA) bus, a parallel Advanced Technology Attachment (PATA) bus, a small computer system interface (SCSI) bus, a FireWire bus, a Fibre Channel connection, a Universal Serial Bus (USB), a PCIe Advanced Switching (PCIe-AS) bus, or the like. In another embodiment, the storage device 220 may be disposed on a communication network 215, such as an Ethernet network, an Infiniband network, SCSI RDMA over a network 215, a storage area network (SAN), a local area network (LAN), a wide area network (WAN) such as the Internet, another wired and/or wireless network 215, or the like.

The host computing device 210 may further comprise a computer-readable storage medium 214. The computer-readable storage medium 214 may comprise executable instructions configured to cause the host computing device 210 (e.g., processor 211) to perform steps of one or more of the methods disclosed herein. Additionally, or in the alternative, the buffering component 250 may be embodied as one or more computer-readable instructions stored on the computer-readable storage medium 214.

A device driver and/or the controller 226, in certain embodiments, may present a logical address space 234 to the host clients 216. As used herein, a logical address space 234 refers to a logical representation of memory resources. The logical address space 234 may comprise a plurality (e.g., range) of logical addresses. As used herein, a logical address refers to any identifier for referencing a memory resource (e.g., data), including, but not limited to: a logical block address (LBA), cylinder/head/sector (CHS) address, a file name, an object identifier, an inode, a Universally Unique Identifier (UUID), a Globally Unique Identifier (GUID), a hash code, a signature, an index entry, a range, an extent, or the like.

A device driver for the storage device 220 may maintain metadata 235, such as a logical to physical address mapping structure, to map logical addresses of the logical address space 234 to media storage locations on the storage device(s) 220. A device driver may be configured to provide storage services to one or more host clients 216. The host clients 216 may include local clients operating on the host computing device 210 and/or remote clients 217 accessible via the network 215 and/or communication interface 213. The host clients 216 may include, but are not limited to: operating systems, file systems, database applications, server applications, kernel-level processes, user-level processes, applications, and the like. In many embodiments, the host client will be a light blockchain client that can allow the host computing device 210 to access one or more blockchain networks.

In many embodiments, the host computing device 210 can include a plurality of virtual machines which may be instantiated or otherwise created based on user-request. As will be understood by those skilled in the art, a host computing device 210 may create a plurality of virtual machines configured as virtual hosts which is limited only on the available computing resources and/or demand. A hypervisor can be available to create, run, and otherwise manage the plurality of virtual machines. Each virtual machine may include a plurality of virtual host clients similar to host clients 216 that may utilize the storage system 202 to store and access data.

The device driver may be further communicatively coupled to one or more storage systems 202 which may include different types and configurations of storage devices 220 including, but not limited to: solid-state storage devices, semiconductor storage devices, SAN storage resources, or the like. The one or more storage devices 220 may comprise one or more respective controllers 226 and non-volatile memory channels 222. The device driver may provide access to the one or more storage devices 220 via any compatible protocols or interface 233 such as, but not limited to, SATA and PCIe. The metadata 235 may be used to manage and/or track data operations performed through the protocols or interfaces 233. The logical address space 234 may comprise a plurality of logical addresses, each corresponding to respective media locations of the one or more storage devices 220. The device driver may maintain metadata 235 comprising any-to-any mappings between logical addresses and media locations. As those skilled in the art will recognize, the number of, and location of the storage devices may change as needed. For example, in Chia node applications, the number of storage devices may increase as additional plots are created and set up for access during farming operations.

A device driver may further comprise and/or be in communication with a storage device interface 239 configured to transfer data, commands, and/or queries to the one or more storage devices 220 over a bus 225, which may include, but is not limited to: a memory bus of a processor 211, a peripheral component interconnect express (PCI Express or PCIe) bus, a serial Advanced Technology Attachment (ATA) bus, a parallel ATA bus, a small computer system interface (SCSI), FireWire, Fibre Channel, a Universal Serial Bus (USB), a PCIe Advanced Switching (PCIe-AS) bus, a network 215, Infiniband, SCSI RDMA, or the like. The storage device interface 239 may communicate with the one or more storage devices 220 using input-output control (IO-CTL) command(s), IO-CTL command extension(s), remote direct memory access, or the like.

The communication interface 213 may comprise one or more network interfaces configured to communicatively couple the host computing device 210 and/or the controller 226 to a network 215 and/or to one or more remote clients 217 (which can act as another host). In many embodiments, the remote clients 217 will be comprised of other blockchain clients that can provide access to one or more blockchain networks. For example, in the embodiment depicted in FIG. 2, the remote clients 217 may comprise other Chia nodes and/or timelords within the Chia network. The controller 226 is part of and/or in communication with one or more storage devices 220. Although FIG. 2 depicts a single storage device 220, the disclosure is not limited in this regard and could be adapted to incorporate any number of storage devices 220.

The storage device 220 may comprise one or more non-volatile memory devices 223 of non-volatile memory channels 222, which may include but is not limited to: ReRAM, Memristor memory, programmable metallization cell memory, phase-change memory (PCM, PCME, PRAM, PCRAM, ovonic unified memory, chalcogenide RAM, or C-RAM), NAND flash memory (e.g., 2D NAND flash memory, 3D NAND flash memory), NOR flash memory, nano random access memory (nano RAM or NRAM), nanocrystal wire-based memory, silicon-oxide based sub-10 nanometer process memory, graphene memory, Silicon Oxide- Nitride-Oxide-Silicon (SONOS), programmable metallization cell (PMC), conductive-bridging RAM (CBRAM), magneto-resistive RAM (MRAM), magnetic storage media (e.g., hard disk, tape), optical storage media, or the like. The one or more non-volatile memory devices 223 of the non-volatile memory channels 222, in certain embodiments, comprise storage class memory (SCM) (e.g., write in place memory, or the like).

While the non-volatile memory channels 222 is referred to herein as “memory media,” in various embodiments, the non-volatile memory channels 222 may more generally comprise one or more non-volatile recording media capable of recording data, which may be referred to as a non-volatile memory medium, a non-volatile memory device, or the like. Further, the storage device 220, in various embodiments, may comprise a non-volatile recording device, a non-volatile memory array 229, a plurality of interconnected storage devices in an array, or the like.

The non-volatile memory channels 222 may comprise one or more non-volatile memory devices 223, which may include, but are not limited to: chips, packages, planes, die, or the like. A controller 226 may be configured to manage data operations on the non-volatile memory channels 222, and may comprise one or more processors, programmable processors (e.g., FPGAs), ASICs, micro-controllers, or the like. In some embodiments, the controller 226 is configured to store data on and/or read data from the non-volatile memory channels 222, to transfer data to/from the storage device 220, and so on.

The controller 226 may be communicatively coupled to the non-volatile memory channels 222 by way of a bus 227. The bus 227 may comprise an I/O bus for communicating data to/from the non-volatile memory devices 223. The bus 227 may further comprise a control bus for communicating addressing and other command and control information to the non-volatile memory devices 223. In some embodiments, the bus 227 may communicatively couple the non-volatile memory devices 223 to the controller 226 in parallel. This parallel access may allow the non-volatile memory devices 223 to be managed as a group, forming a non-volatile memory array 229. The non-volatile memory devices 223 may be partitioned into respective logical memory units (e.g., logical pages) and/or logical memory divisions (e.g., logical blocks). The logical memory units may be formed by logically combining physical memory units of each of the non-volatile memory devices 223.

The controller 226 may organize a block of word lines within a non-volatile memory device 223, in certain embodiments, using addresses of the word lines, such that the word lines are logically organized into a monotonically increasing sequence (e.g., decoding and/ or translating addresses for word lines into a monotonically increasing sequence, or the like). In a further embodiment, word lines of a block within a non-volatile memory device 223 may be physically arranged in a monotonically increasing sequence of word line addresses, with consecutively addressed word lines also being physically adjacent (e.g., WL0, WL1, WL2, ... WLN).

The controller 226 may comprise and/or be in communication with a device driver executing on the host computing device 210. A device driver may provide storage services to the host clients 216 via one or more interfaces 233. A device driver may further comprise a storage device interface 239 that is configured to transfer data, commands, and/or queries to the controller 226 over a bus 225, as described above.

Finally, a light blockchain client 240 may be configured to communicate with the host computing device 210 through one or more communication channels or ports to access at least one blockchain. In many embodiments, access to the blockchain is done to verify the current ownership of the storage device and to verify encryption and/or decryption requests made by a user. In some embodiments, the user can provide a key that can be verified by accessing the blockchain and performing one or more operations to determine ownership of the device and verify that the user requesting access is authorized. This can be done in a number of ways including, but not limited to, utilizing a pair of addresses such as a signature scheme key and an encryption scheme key, such as an asymmetric key.

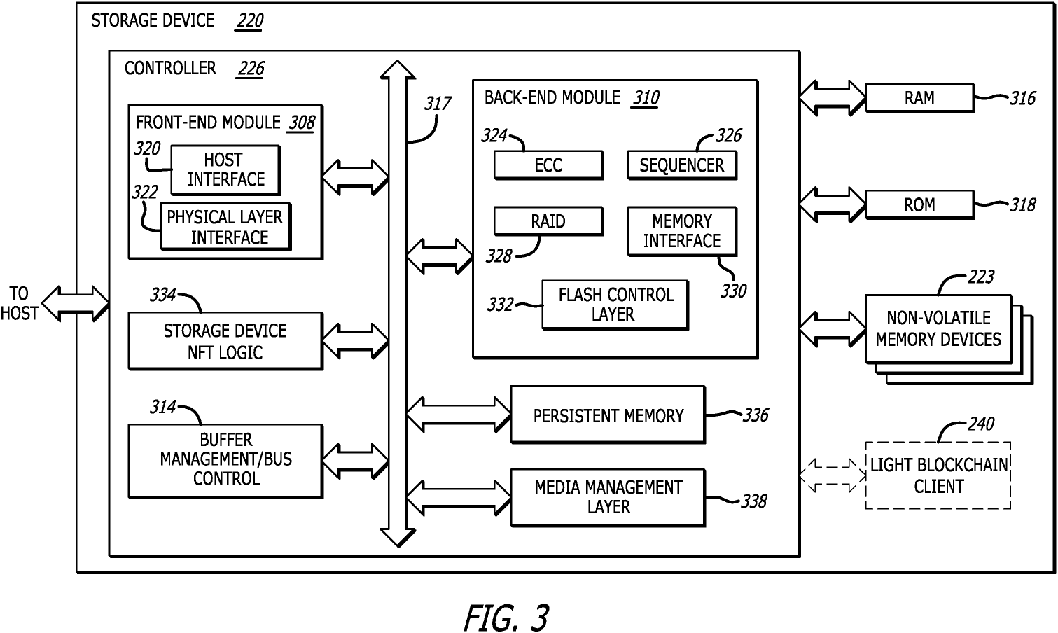

Referring to FIG. 3, a schematic block diagram of an example storage device 220 suitable for being associated with a non-fungible token in accordance with various embodiments of the disclosure is shown. The controller 226 may include a front-end module 308 that interfaces with a host via a plurality of high priority and low priority communication channels, a back-end module 310 that interfaces with the non-volatile memory devices 223, and various other modules that perform various functions of the storage device 220. In some examples, each module may just be the portion of the memory that comprises instructions executable with the processor to implement the features of the corresponding module without the module including any other hardware. Because each module includes at least some hardware even when the included hardware comprises software, each module may be interchangeably referred to as a hardware module.

The controller 226 may include a buffer management/bus control module 314 that manages buffers in random access memory (RAM) 316 and controls the internal bus arbitration for communication on an internal communications bus 317 of the controller 226. A read only memory (ROM) 318 may store and/or access system boot code. Although illustrated in FIG. 3 as located separately from the controller 226, in other embodiments one or both of the RAM 316 and the ROM 318 may be located within the controller 226. In yet other embodiments, portions of RAM 316 and ROM 318 may be located both within the controller 226 and outside the controller 226. Further, in some implementations, the controller 226, the RAM 316, and the ROM 318 may be located on separate semiconductor dies. As discussed below, in one implementation, the submission queues and the completion queues may be stored in a controller memory buffer, which may be housed in RAM 316.

Additionally, the front-end module 308 may include a host interface 320 and a physical layer interface 322 that provides the electrical interface with the host or next level storage controller. The choice of the type of the host interface 320 can depend on the type of memory being used. Example types of the host interfaces 320 may include, but are not limited to, SATA, SATA Express, SAS, Fibre Channel, USB, PCIe, and NVMe. The host interface 320 may typically facilitate transfer for data, control signals, and timing signals.

The back-end module 310 may include an error correction controller (ECC) engine 324 that encodes the data bytes received from the host and decodes and error corrects the data bytes read from the non-volatile memory devices 223. The back-end module 310 may also include a command sequencer 326 that generates command sequences, such as program, read, and erase command sequences, to be transmitted to the non-volatile memory devices 223. Additionally, the back-end module 310 may include a RAID (Redundant Array of Independent Drives) module 328 that manages generation of RAID parity and recovery of failed data. The RAID parity may be used as an additional level of integrity protection for the data being written into the storage device 220. In some cases, the RAID module 328 may be a part of the ECC engine 324. A memory interface 330 provides the command sequences to the non-volatile memory devices 223 and receives status information from the non-volatile memory devices 223. Along with the command sequences and status information, data to be programmed into and read from the non-volatile memory devices 223 may be communicated through the memory interface 330. A flash control layer 332 may control the overall operation of back-end module 310.

Additional modules of the storage device 220 illustrated in FIG. 3 may include a media management layer 338, which performs wear leveling of memory cells of the non-volatile memory devices 223. The storage device 220 may also include other discrete components 340, such as external electrical interfaces, external RAM, resistors, capacitors, or other components that may interface with controller 226. In alternative embodiments, one or more of the RAID modules 328, media management layer 338 and buffer management/bus control module 314 are optional components that may not be necessary in the controller 226.

Finally, the controller 226 may also comprise a storage device NFT logic 334 that can be configured to associate the storage device 220 with an NFT on an associated blockchain. In many embodiments, the storage device NFT logic 334 can be utilized by the controller 226 to encrypt and decrypt data stored within the non-volatile memory devices 223 as described above. In more embodiments, the storage device NFT logic 334 can be configured to generate and handle keys and transfer of ownership as also described above. In still further embodiments, the storage device NFT logic 334 can be configured to receive requests for unique identifier information and provide that information which can be utilized to determine the provenance of the storage device 220 through historical records stored within an NFT on an associated blockchain. In further embodiments, the storage device NFT logic 334 can carry out processes similar to the processes discussed in more detail within FIGS. 1 - 2 and 4 - 8.

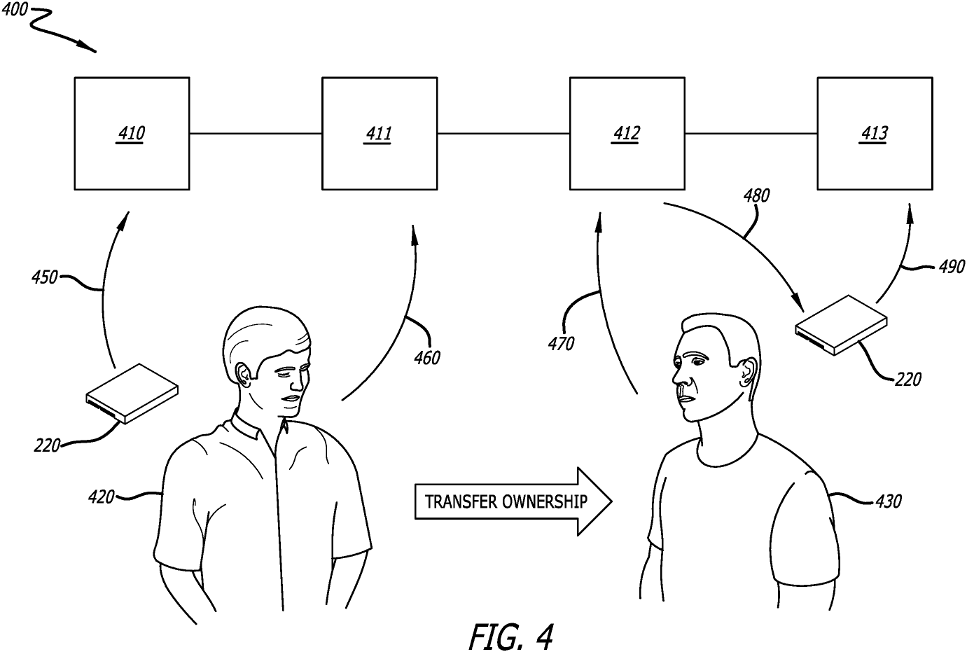

Referring to FIG. 4, an example process 400 of transferring ownership of a storage device 200 associated with a non-fungible token in accordance with various embodiments of the disclosure is shown. During manufacture, the storage device 220 can be provided a unique identifier or address pair as described above. Prior to deployment, this data is added (450) to a first blockchain block 410. Subsequently, a first owner 420 purchases the storage device 220 and accesses (460) a second blockchain block 411 which links to the first blockchain block 410 that proves that the storage device 220 is authentic and has come from the manufacturer as advertised. The first owner 420 can then operate the storage device 220 normally.

However, the first owner 420 can subsequently begin a process to sell the storage device 220 to a second owner 430. The first owner 420 can, in certain embodiments, provide an ownership transfer request to the storage device 220 prior to delivering to the second owner 430. In this way, the storage device 220 can verify the transfer request and, if determined to be from the first owner 420, generate a new address pair or other data necessary to restrict access to the data within the device. In this way, the second owner 430 would not be able to access data already stored on the storage device 220 but could add new data to the storage device 220 that they would be able to access with the new key/address/access data.

Once received, the second owner 430 may initiate (470) a transfer request to the storage device 220 which can verify that the request is coming from the first owner 420. This transfer request could access a third blockchain block 412 which is connected to the first and second blockchain block 410-411 to verify that the provided data aligns with historical records as described in more detail above. This historical record can be transferred (480) back to the storage device 220 for verification. Once verified, the storage device 220 can subsequently transfer (490) new ownership data to a fourth blockchain block 413 within the associated blockchain system. Although in further embodiments, the storage device may not directly add data to any blockchain. In these embodiments, data added to the blockchain may be done by the user through one or more applications. In some embodiments, data may not be added to the blockchain at all.

As those skilled in the art will recognize, the blockchain system is shown in a simplified form and the number of blocks between actions may vary depending on a number of factors. The example depicted in FIG. 4 is utilized for illustrative purposes and it should be recognized that any number of blockchain blocks may exist within a blockchain system, and steps taken during any process described herein may occur on the same block, or over a large number of blocks. In some embodiments, the storage device 220 may access multiple blockchains. For example, there may be a first blockchain accessed to determine provenance, while a second blockchain is accessed to determine and/or transfer ownership.

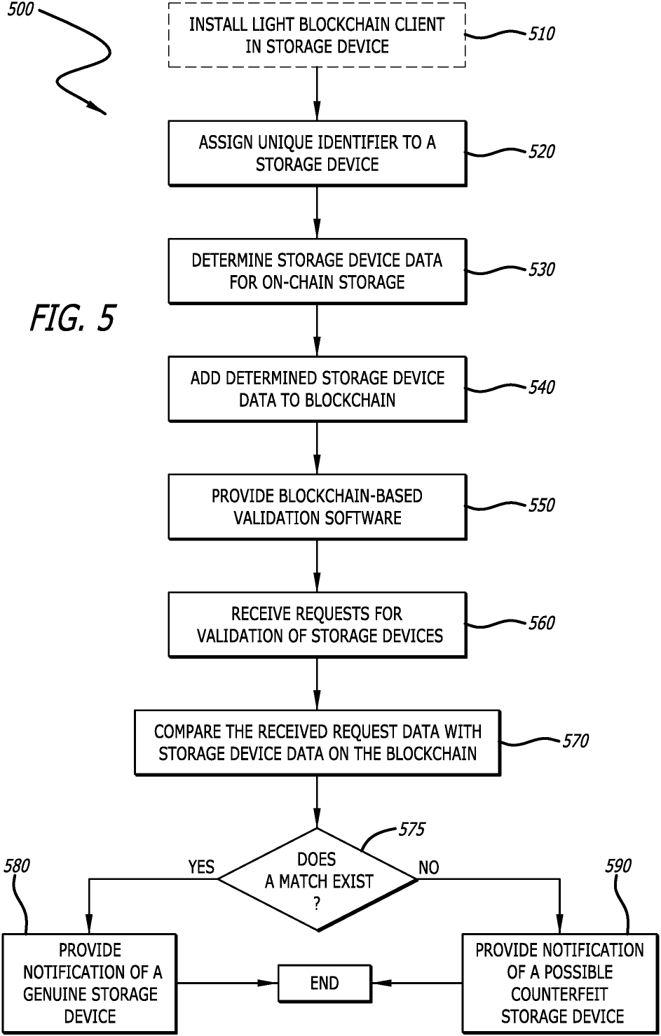

Referring to FIG. 5, a flowchart depicting a process 500 for determining the provenance of a storage device associated with a non-fungible token in accordance with various embodiments of the disclosure is shown. In many embodiments, the process 500 can begin by optionally installing a light blockchain client in a storage device (block 510). As previously discussed, storage devices can be configured to only interact or provide data related to manufacture. In these instances, it can be determined if the storage device was a genuine device sold by the manufacturer, or if it is potentially counterfeit, but no subsequent data or transfers can be done. For these devices, a light blockchain client may not be needed and may not be installed during manufacture (or are removed later). However, when the entire provenance of a device is desired, the storage device can be configured to interact with the blockchain (via a host or an internal communication application) that can update ownership within the blockchain associated with the device.

In additional embodiments, the process 500 can assigned a unique identifier to a storage device (block 520). The unique identifier can be generated by the manufacturer and assigned during the manufacturing process. In certain embodiments, the unique identifier can be used as a key and/or hash that can be compatible with storage or conversion to blockchain data. In further embodiments, the process 500 can determine storage device data for on-chain storage within a blockchain (block 530). By way of example and not limitation, storage device data may include data associated with the serial number of the device, storage capacity of the device, manufacture date, batch number, manufacturer, and/or device type. Once determined, the process 500 can format and add the storage device data to a blockchain (block 540). In many embodiments, the storage device data is added as a non-fungible token that is associated with the unique identifier such that the only a single device is associated with the non-fungible token that is generated with the storage device data.

Once added to the blockchain, the device can subsequently be deployed into the field where a user can desire to validate that the storage device is genuine and not a counterfeit device. In various embodiments, blockchain-based validation software can be provided to users (block 550). In some embodiments, the blockchain-based validation software can be provided as a standalone application or via a web-based delivery (such as a web page). The blockchain-based validation software can be configured to receive requests for validation of storage devices (block 560). These requests can include at least the unique identifier associated with the storage device.

In a variety of embodiments, the blockchain-based validation software may (or handoff a request to) compare the received request data with storage device data on the blockchain (block 570). Often, this can be done by attempting to match an entry in the blockchain to data within the received request. However, those skilled in the art will recognize that other methods of validation may be utilized depending on the application desired. Upon comparison, the process 500 can determine if a match exists (block 575). If a match is found, the process 500 can generate and provide a notification indicating that the storage device is genuine (block 580). However, if no match is determined to exist, then the process 500 can generate and provide a notification that the storage device is potentially counterfeit. In certain embodiments, the process 500 may simply notify the user that no match is found within the blockchain of the storage device.

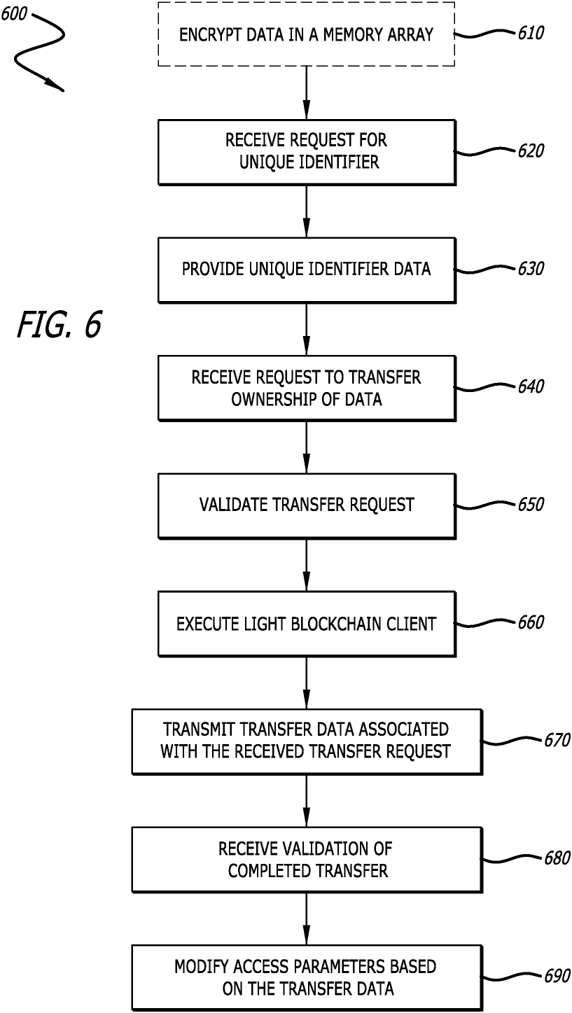

Referring to FIG. 6, a flowchart depicting a process 600 for operating a storage device associated with a non-fungible token in accordance with various embodiments of the disclosure is shown. In certain embodiments, the process 600 may encrypt data within a memory array of a storage device (block 610). In this way, only the owner of the storage device that has the specific unique identifier and/or encryption key can access stored data. At one or more points during operation, the device may receive a request for the unique identifier associated with the device (block 620). In some embodiments, this can occur when a user wishes to verify the provenance of the storage device, or transfer ownership of the device to a new owner. Upon receipt of the request, the process 600 can provide the unique identifier data (block 630). In a variety of embodiments, this data is provided to a host-computing device for further processing.

In further embodiments, the process 640 can receive a request to transfer the ownership of the device to a new owner (block 640). This request can often be validated to determine the authenticity of the request and to verify that it has come from the current owner (block 650). In certain embodiments, the storage device can carry out this validation by comparing it against current user data. Upon validation, the process 600 can execute a light blockchain client that resides within a memory of the storage device (block 660). The light blockchain client may attempt to interact with the blockchain associated with the storage device.

Once a connection has been established, the process 600 can transmit transfer data associated with the received transfer request (block 670). Those skilled in the art can recognize that the data transferred can often be related and/or formatted to add a new block to the blockchain associated with the storge device which can indicate a new owner’s information or that a new identifier is being generated. In more embodiments, the process 600 can wait until a validation of the completed transfer is received (block 680). This can often be due to having to wait for the new block to be added and verified on the associated blockchain, which may take some period of time. Upon receiving the validation of the completed transfer, the process 600 can modify the access parameters of the storage device based on at least the transfer data that was received (block 690). However, as described below, certain embodiments may simply generate new data that is configured to only be delivered to the new owner for future use and access to the storage device.

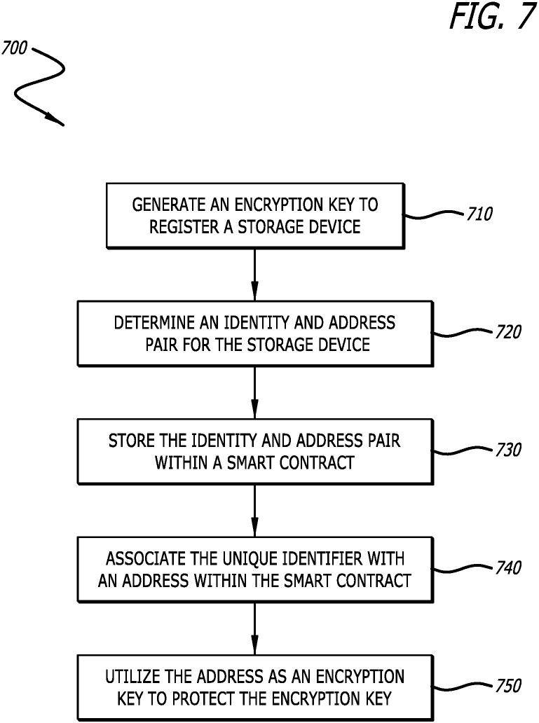

Referring to FIG. 7, a flowchart depicting a process 700 for securing a storage device associated with a non-fungible token in accordance with various embodiments of the disclosure is shown. In many embodiments, the process 700 can begin by generating an encryption key to register a storage device (block 710). In additional embodiments, a unique identifier can also be generated if the drive was just manufactured. As described above, the encryption key can be utilized to unlock any data that has been encrypted within a memory array on the storage device.

In further embodiments, the process 700 can determine an identity and address pair for the storage device (block 720). As also described above, the address can be comprised of the encryption key as well as another secret key that only the owner should know. In some embodiments, this step may be completed after the drive has been sold such that the first owner can create the first address. However, in a number of embodiments, the manufacturer will determine a first secret key to generate the address and subsequent address and identity pair. In these embodiments, the manufacturer may provide the secret key to the first owner which can then be used by the first owner or may be utilized to change ownership such that the first owner can create their own secret key that even the manufacturer will not have access to. For example, the initial secret key may be provided on a unique paper that is sold with the storage device. In other embodiments, the initial secret key may be emailed to the first owner upon purchase. The first owner can either enter the secret key through specialized ownership transfer software or a web-based tool that can have access to the blockchain to create a blockchain-based response to transfer ownership which can be received by the storage device to update the ownership information.

In a variety of embodiments, the process 700 can store the identity and address pair within a smart contract system utilized by the NFT (block 730). As described above, smart contracts can be utilized to add specific functionality to a blockchain system. These functions can be configured to allow for use in the application described herein. The process 700 can associate the unique identifier with an address within the smart contract (block 740). The ownership of the storage device can thus be locked down and verified through the blockchain system. Finally, the process 700 can utilize the address as an encryption key to protection the original encryption key (block 750). In this way, the original encryption key can avoid being posted on the public blockchain and avoid attacks and loss of data to the storage device.

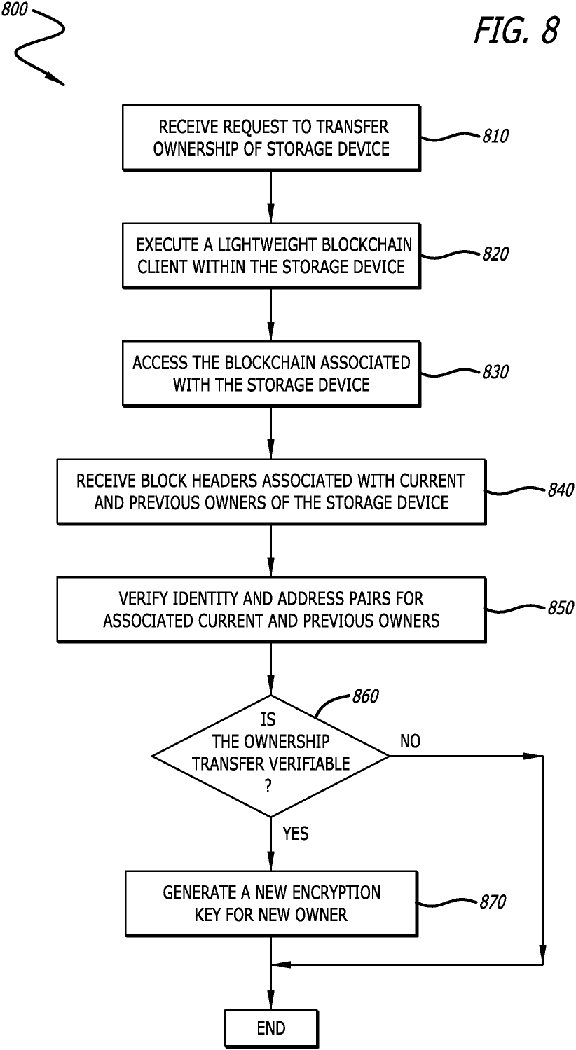

Referring to FIG. 8, a flowchart depicting a process 800 for transferring ownership of a storage device associated with a non-fungible token in accordance with various embodiments of the disclosure is shown. In many embodiments, the process 800 can begin upon receiving a request to transfer ownership of the storage device (block 810). This request typically is received from the original owner who has entered their private key (i.e., password) to verify that they are the owner and that the transfer request should occur. In further embodiments, the process 800 can execute a lightweight blockchain client within the storage device (block 820). As described above, this lightweight blockchain client can be operated on and executed by a controller within the storage device. However, in some embodiments, the storage device may communicate with an external application that can function as the lightweight blockchain client.

In additional embodiments, the process 800 can subsequently access the blockchain associated with the storage device (block 830). Upon gaining access, the storage device can receive block headers associated with the current and any previous owners of the storage device (block 840). However, in a variety of embodiments, the storage device may have already stored data relating to previous owners and may simply just download the current owner’s data. Once downloaded, the process 800 can attempt to verify the identity and address pairs for the associated current and previous owners (block 850).

The process 800 can determine if the ownership transfer is verifiable (block 860). If the transfer request cannot be verified, then the process 800 can simply end and attempt to start over if a new request is received. In many embodiments, the process 800 can also generate a notification of the error and/or provide more information to the user as to why the verification could not occur. However, when the ownership transfer can be verified, the process 800 can generate a new encryption key for the new owner (block 870). This new encryption key can be delivered in a variety of ways including output by the host-computing device. In further embodiments, there may be a specialized ownership transfer software that may provide for a first owner to enter their secret key for verification of the ownership transfer and, upon verification, transmit the newly generated encryption key to a method of communication previously provided by the second owner. Therefore, a first owner may enter their information into a web-portal with the ownership transfer software, and the new encryption key can be emailed, texted, or otherwise sent to the second owner such that the first owner will not know what the new encryption key is.

In some embodiments, this process may be done by the first owner, and the new encryption key is held “in escrow” or with the manufacturer or other trusted third party until the storage device is sold and assigned to the second owner. In this way, the owner may not need to be present for each device sold. Indeed, it is contemplated that this process can be utilized in a batch process such that ownership can be transferred over a large number of storage devices quickly, such as when a system administrator needs to sell many drives from an organization to another organization, etc.

It is further contemplated that each storage device may be nested into multiple NFT groups, such that a storage device may have two unique identifiers allowing association with a first NFT tied to the device itself and a second NFT tied to a group of devices that can be assigned and/or transferred between two owners as a block of storage devices, thus eliminating the need to transfer ownership of each drive individually. The encryption keys may thus be encrypted yet again with another second secret key that is maintained by the group owner such as a business or other organizational entity.

Information as herein shown and described in detail is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments that might become obvious to those skilled in the art, and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A method for indicating the provenance of a device, comprising:
assigning a unique identifier to the device;
determining device data for on-chain storage;
adding determined device data to a blockchain;
providing blockchain-based validation software; and
receiving a request for validation of the device via the blockchain-based validation software wherein the request includes the unique identifier;
accessing the blockchain;
searching the blockchain for added device data;
determining if a match exists within the blockchain with the received unique identifier associated with the request.

2. The method of claim 1, wherein the device data is associated with the unique identifier.

3. The method of claim 2, wherein the device data is formatted as a non-fungible token (NFT).

4. The method of claim 3, wherein, in response to determining that a match exists, providing a notification that the device is genuine.

5. The method of claim 3, wherein, in response to determining that a match does not exist, providing a notification that the device is potentially counterfeit.

6. A device comprising:
a processor;
a communication port;
a unique identifier;
a memory array comprising a plurality of memory devices; and a storage device non-fungible token (NFT) logic configured to:
generate a first encryption key;
encrypt received data prior to storing on the memory array with the first encryption key;
receive a request to transfer ownership;
verify the received request;
generate a second encryption key; and
encrypt subsequently received data prior to storing on the memory array with the second encryption key.

7. The device of claim 6, wherein the unique identifier is assigned to the device during the manufacturing process.

8. The device of claim 6, wherein the received ownership transfer request is verified via accessing a blockchain associated with the storage device.

9. The device of claim 8, wherein the storage device NFT logic is further configured to operate a lightweight blockchain client, wherein the associated blockchain is accessed via the lightweight blockchain client.

10. The device of claim 9, wherein the lightweight blockchain client receives block headers associated with the current and previous owners of the device.

11. The device of claim 10, wherein the block headers comprise identity and address pairs associated with one or more owners of the device.

12. The device of claim 11, wherein storage device NFT logic is further configured to verify the identity and address pairs of the current and previous owners.

13. The device of claim 12, wherein, upon successful verification of the identity and address pairs of the current and previous owners, the second encryption key can be generated.

14. The device of claim 6, wherein the device is associated with an NFT on a blockchain prior to deployment.

15. The device of claim 14, wherein the association with the NFT comprises at least the unique identifier and an address.

16. The device of claim 15, wherein the address is comprised of at least the first encryption key.

17. The device of claim 14, wherein the NFT is formatted as a smart contract.

18. The device of claim 15, wherein the smart contract is operated on the Ethereum blockchain.

19. A storage device comprising:
a processor;
a communication port;
a memory array comprising a plurality of memory devices;
a storage device non-fungible token (NFT) logic configured to:
verify ownership of the device to a first owner;
execute a lightweight blockchain client logic configured to gain access to a blockchain system through the communication port and update ownership of the device by adding new ownership data to the blockchain.

20. The storage device of claim 19, wherein the verification of ownership of the device to a first owner is based on at least receiving a blockchain-based response generated by providing a unique key assigned during the manufacturing process.
